(19) United States
(12) Patent Application Publication
(10) Pub. No.: US 2023/0170996 A1
(43) Pub. Date: Jun. 1, 2023

(54) OPTICAL TRANSMISSION DEVICE AND OPTICAL FIBER

(71) Applicant: NITTO DENKO CORPORATION, Osaka (JP)

(72) Inventors: Yuichi TSUJITA, Osaka (JP); Kazumasa OKADA, Osaka (JP); Takeshi TANAKA, Osaka (JP); Keita KIYOSHIMA, Osaka (JP); Yoshinori OSAKI, Osaka (JP)

(73) Assignee: NITTO DENKO CORPORATION, Osaka (JP)

(21) Appl. No.: 17/917,759

(22) PCT Filed: Apr. 7, 2021
(86) PCT No.: PCT/JP2021/014737

§ 371 Date: Oct. 7, 2022

(30) Foreign Application Priority Data
Apr. 10, 2020 (JP) 2020-070923

(51) Int. Cl. H04B 10/2581; H04B 10/2575

(52) U.S. Cl. CPC H04B 10/2581; H04B 10/2575; H04B 10/2507

(57) ABSTRACT

Provided is an optical transmission system that performs RoF transmission of an RF signal. The optical transmission system includes an electro-optical conversion device for receiving an RF signal, converting the RF signal into an optical signal, and transmitting the optical signal; a multimode optical fiber for transmitting the optical signal transmitted from the electro-optical conversion device; and an opto-electrical conversion device for converting the optical signal transmitted from the optical fiber into an RF signal and transmitting the RF signal. The optical fiber has a numerical aperture (NA) of 0.13 or more and 0.22 or less.

### TECHNICAL FIELD

The present invention relates to an optical transmission system and an optical fiber.

### BACKGROUND ART

Conventionally, an optical transmission system which performs RoF transmission of an RF signal via an optical fiber has been known (ref: for example, Patent Document 1 below).

### CITATION LIST

### Patent Document

Patent Document 1: Japanese Unexamined Patent Publication No. 2014-90240

### SUMMARY OF THE INVENTION

### Problem to Be Solved by the Invention

However, in the RoF transmission disclosed in Patent Document 1, there is a problem that distortion caused by a trailing phenomenon is generated near a desired signal frequency (ref: FIG. 4 of the present application).

Meanwhile, reduction in loss of light in the optical transmission system is also required.

The present invention provides an optical transmission system and an optical fiber capable of suppressing distortion and reducing loss of light.

### Means for Solving the Problem

The present invention (1) includes an optical transmission system performing RoF transmission of an RF signal, the optical transmission system including an electro-optical conversion device for receiving an RF signal, converting the RF signal into an optical signal, and transmitting the optical signal; a multimode optical fiber for transmitting the optical signal transmitted from the electro-optical conversion device; and an opto-electrical conversion device for converting the optical signal transmitted from the optical fiber into an RF signal and transmitting the RF signal, in which the optical fiber has a numerical aperture of 0.13 or more and 0.22 or less.

According to the optical transmission system, since the optical fiber has a numerical aperture of 0.22 or less, it is possible to suppress distortion. Further, since the optical fiber has a numerical aperture of 0.13 or more, it is possible to reduce loss of light.

The present invention (2) includes the optical transmission system described in (1), in which the optical fiber includes a core; and a clad covering the core, and the clad has one layer.

According to the optical transmission system, since the clad of the optical fiber has one layer, it is possible to reliably set the numerical aperture of the optical fiber in the above range.

The present invention (3) includes the optical transmission system described in (1) or (2), in which the core has an inner diameter of 30 µm or more and 120 µm or less.

According to the optical transmission system, since the core has an inner diameter of 30 µm or more, it is possible to reduce coupling loss of light from the electro-optical conversion device to the optical fiber. According to the optical transmission system, since the core has an inner diameter of 120 µm or less, it is possible to reduce coupling loss from the optical fiber to the opto-electrical conversion device.

The present invention (4) includes the optical transmission system described in any one of (1) to (3), in which an end surface in an optical-axis direction of the optical fiber is inclined with respect to a direction orthogonal to the optical-axis direction.

According to the optical transmission system, since the end surface in the optical-axis direction of the optical fiber is inclined with respect to the direction orthogonal to the optical-axis direction, it is possible to reduce noise caused by return light which is reflected back by the end surface of the optical fiber.

The present invention (5) includes the optical transmission system described in any one of (1) to (4), in which a material of the optical fiber is plastic.

According to the optical transmission system, since the material of the optical fiber is plastic, it is excellent in bending resistance.

The present invention (6) includes an optical fiber in an optical transmission system performing RoF transmission of an RF signal, the optical transmission system including an electro-optical conversion device for receiving an RF signal, converting the RF signal into an optical signal, and transmitting the optical signal; a multimode optical fiber for transmitting the optical signal transmitted from the electro-optical conversion device; and an opto-electrical conversion device for converting the optical signal transmitted from the optical fiber into an RF signal and transmitting the RF signal, the optical fiber having a numerical aperture of 0.13 or more and 0.22 or less.

Since the optical fiber has a numerical aperture of 0.22 or less, it is possible to suppress distortion. Further, since the optical fiber has a numerical aperture of 0.13 or more, it is possible to reduce loss of light.

### Effects of the Invention

According to the optical transmission system including the optical fiber of the present invention, it is possible to suppress distortion and to reduce loss of light.

### BRIEF DESCRIPTION OF THE DRAWINGS

FIG. 1 shows a schematic cross-sectional view of one embodiment of an optical transmission system of the present invention.

FIGS. 2A to 2B are cross-sectional views of a modified example of an optical fiber of the optical transmission system shown in FIG. 1: FIG. 2A is one end surface in an optical-axis direction of the optical fiber; and FIG. 2B is the other end surface in the optical-axis direction of the optical fiber.

FIG. 3 is an intensity spectrum of an RF signal to be RoF transmitted by the optical transmission system of Example 2.

FIG. 4 is an intensity spectrum of an RF signal to be RoF transmitted by the optical transmission system of Comparative Example 1.

### DESCRIPTION OF THE EMBODIMENTS

### One Embodiment of Optical Transmission System

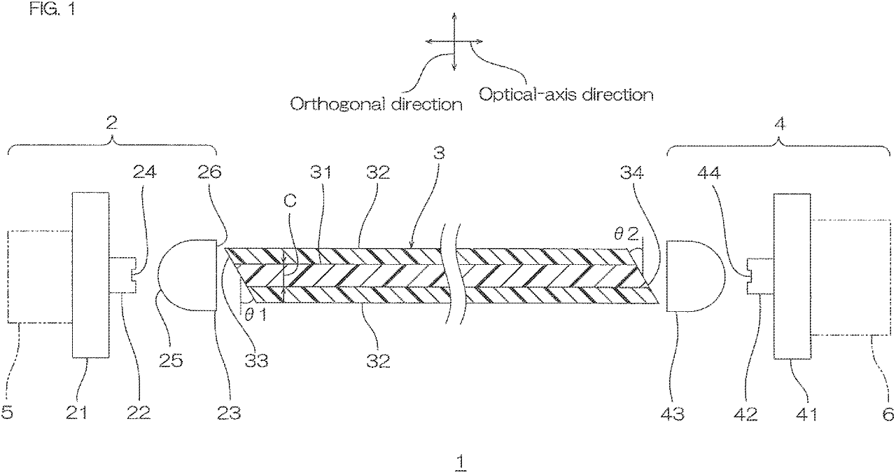

One embodiment of an optical transmission system of the present invention is described with reference to FIG. 1.

An optical transmission system 1 performs RoF transmission of an RF signal via an optical fiber 3 (to be described later). Examples of the RF signal include an electromagnetic wave having a frequency band used for wireless communication. Specific examples of the RF signal include FM radio waves, radio waves of television broadcasting, fifth generation (5G) radio waves, wireless fidelity (Wi-Fi) radio waves, signals of which frequencies are converted into intermediate frequencies in order to transmit these radio waves through wiring, and broadcasting signals sent from a cable television base station.

RoF transmission is referred to as Radio on Fiber transmission. The RoF transmission is a method in which each of a plurality of channels is allocated to each of a plurality of frequency bands to transmit an RF signal.

The optical transmission system 1 includes an electro-optical conversion device 2, an optical fiber 3, and an opto-electrical conversion device 4.

The electro-optical conversion device 2 receives an RF signal, converts the RF signal into an optical signal, and transmits the optical signal. The electro-optical conversion device 2 includes a stem 21, a light source 22, and a lens 23.

The stem 21 has a plate shape having a thickness, and has one surface and the other surface that are disposed to face each other in the thickness direction. An RF signal primary receiving device 5 (phantom line) such as an RF signal antenna (specifically, a television broadcasting antenna) is connected to the other surface of the stem 21.

The light source 22 is disposed on one surface of the stem 21. The light source 22 has a generally rectangular parallelepiped shape, and has one surface and the other surface in the thickness direction. The other surface faces the stem 21, and one surface faces one side in the thickness direction. The light source 22 is electrically connected to the stem 21. The light source 22 has an emission port 24 of light disposed in one surface. The emission port 24 faces one side in the thickness direction of the light source 22 and has a generally circular shape in plan view. A diameter (inner diameter) of the emission port 24 is appropriately set corresponding to an inner diameter C of a core 31 of the optical fiber 3 to be described next, or in accordance with a required transmission band. Specifically, the diameter of the emission port 24 is, for example, 20 µm or less, preferably 10 µm or less. As the light source 22, for example, a laser diode, preferably, a surface emitting laser diode (VCSEL: vertical cavity surface emitting laser diode) is used.

The lens 23 is disposed to face the light source 22 at a spaced interval from the light source 22 at the opposite side of the stem 21. The lens 23 has a protruding surface 25 which is curved so as to approach the light source 22 toward the center in a plane direction, and a flat surface 26 facing the protruding surface 25. The flat surface 26 of the lens 23 is spaced apart from a top of the protruding surface 25 at one side in the thickness direction. As the electro-optical conversion device 2, a commercially available product (optical transmission subassembly: Transmitter Optical SubAssembly (TOSA) or the like) can be used.

In the electro-optical conversion device 2, the RF signal input from the RF signal primary receiving device 5 to the stem 21 is input to the light source 22. Then, the RF signal is converted into an optical signal in the light source 22. The optical signal is emitted (exits) from the emission port 24 of the light source 22, condensed with the lens 23, and thereafter transmitted (input) to the optical fiber 3.

The optical fiber 3 is a multimode optical fiber. The optical fiber 3 performs multimode transmission of the optical signal transmitted from the electro-optical conversion device 2. Examples of a material of the optical fiber 3 include translucent materials such as plastic and glass, and from the viewpoint of improving bending resistance, preferably, plastic is used. Examples of the plastic include a fluorine resin, an acrylic resin, and an epoxy resin.

The optical fiber 3 includes the core 31, and a clad 32 disposed on its peripheral surface (outer front surface in an orthogonal direction which is orthogonal to an optical-axis direction). Preferably, the optical fiber 3 includes the core 31 and the clad 32 only, and does not include a second clad (not shown) disposed on the peripheral surface of the clad 32. That is, preferably, the optical fiber 3 does not include two layers of the clad 32 and the second clad (not shown) but includes only one layer of the clad 32. When the optical fiber 3 includes the core 31 and the clad 32 only, it is possible to reliably set a numerical aperture of the optical fiber 3 in a range to be described next. However, the optical fiber 3 may be covered with a protective film for surface protection or reinforcement, the protective film made of a material that is opaque to light transmitted to an outer front surface of the clad 32 or a material having a larger refractive index than the clad 32.

The core 31 has, for example, a generally cylindrical shape extending along the optical axis of the optical fiber 3.

The core 31 may have a refractive index distribution in a radial direction, or may have a constant refractive index in the radial direction. The optical fiber 3 in which the core 31 has a refractive index distribution is a GI (graded index) type optical fiber. The optical fiber 3 in which the core 31 has a constant refractive index is an SI (step index) type optical fiber.

The core 31 has an inner diameter C of, for example, 10 µm or more, preferably 30 µm or more, and for example, 200 µm or less, preferably 120 µm or less. When the inner diameter C of the core 31 is the above-described lower limit or more, it is possible to reduce coupling loss of light from the electro-optical conversion device 2 to the optical fiber 3. When the inner diameter C of the core 31 is the above-described upper limit or less, it is possible to reduce coupling loss of light from the optical fiber 3 to the opto-electrical conversion device 4. The inner diameter C of the core 31 is constant in the optical-axis direction of the optical fiber 3.

The clad 32 has a generally cylindrical shape sharing the central axis with the core 31. The refractive index of the clad 32 is lower than that of the core 31. When the refractive indexes of the core 31 and the clad 32 are adjusted so that the numerical aperture of the optical fiber 3 to be described later is within a desired range. The clad 32 has a thickness of, for example, 0.5 µm or more, preferably 5 µm or more, and for example, 300 µm or less, preferably 250 µm or less. The thickness of the clad 32 is a value obtained by subtracting the inner diameter C of the core 31 from an outer diameter of the optical fiber 3 and dividing the resulting value by 2.

Both end surfaces 33, 34 in the optical-axis direction of the optical fiber 3 are inclined with respect to the orthogonal direction. The end surfaces 33, 34 in the optical-axis direction of the optical fiber 3 are one end surface 33 disposed to face the electro-optical conversion device 2 and the other end surface 34 disposed to face the opto-electrical conversion device 4.

An inclination angle θ1 of one end surface 33 is represented by an angle θ1 (an angle smaller than its supplementary angle) formed by one end surface 33 and the orthogonal direction. Specifically, the inclination angle θ1 is, for example, above 0 degrees, preferably 5 degrees or more, more preferably 12 degrees or more, even more preferably 18 degrees or more, and for example, 40 degrees or less, preferably 30 degrees or less, more preferably 25 degrees or less. When the inclination angle θ1 of one end surface 33 is the above-described lower limit or more, it is possible to suppress the generation of return light at one end surface 33 and to suppress noise as well. When the inclination angle θ1 of one end surface 33 is the above-described upper limit or less, it is possible to reduce coupling loss of light from the electro-optical conversion device 2 to the optical fiber 3.

An inclination angle θ2 of the other end surface 34 is represented by an angle θ2 (an angle smaller than its supplementary angle) formed by the other end surface 34 and the orthogonal direction. Specifically, the inclination angle θ2 is, for example, above 0 degrees, preferably 5 degrees or more, more preferably 12 degrees or more, even more preferably 18 degrees or more, and for example, 40 degrees or less, preferably 30 degrees or less, more preferably 25 degrees or less. When the inclination angle θ2 of the other end surface 34 is the above-described lower limit or more, it is possible to suppress the generation of return light at the other end surface 34 and to suppress noise as well. When the inclination angle θ2 of the other end surface 34 is the above-described upper limit or less, it is possible to reduce coupling loss of light from the optical fiber 3 to the opto-electrical conversion device 4.

The optical fiber 3 has an outer diameter of, for example, 0.1 mm or more, preferably 0.4 mm or more, and for example, 2 mm or less, preferably 1.5 mm or less.

The optical fiber 3 has a numerical aperture (NA) of 0.13 or more and 0.22 or less. On the one hand, when the numerical aperture of the optical fiber 3 is below 0.13, the coupling loss of light from the electro-optical conversion device 2 to the optical fiber 3 and the coupling loss of light from the optical fiber 3 to the opto-electrical conversion device 4 increase. On the other hand, when the numerical aperture of the optical fiber 3 is above 0.22, a higher mode affects, and it is therefore impossible to suppress distortion.

When the clad 32 has only one layer, the numerical aperture of the optical fiber 3 is determined by the following formula.

$$\text{NA} = \sqrt{{n}_{1} {}^{2} - {n}_{2} {}^{2}}$$

wherein NA represents a numerical aperture, n₁ represents the refractive index of the core 31, and n₂ represents the refractive index of the clad 32.

As the optical fiber 3, a commercially available product can be used. When the optical fiber 3 is a commercially available product, a numerical aperture described in the catalog is adopted as is as the numerical aperture of the optical fiber 3.

The opto-electrical conversion device 4 converts the multimode optical signal transmitted from the optical fiber 3 into an RF signal, and transmits the RF signal. The opto-electrical conversion device 4 includes a second stem 41, a light receiving element 42, and a second lens 43. The second stem 41, the light receiving element 42, and the second lens 43 are disposed generally symmetrically with the stem 21, the light source 22 and the lens 23, respectively, of the electro-optical conversion device 2 described above with respect to the optical fiber 3.

The second stem 41 has the same configuration as the stem 21 of the electro-optical conversion device 2. An RF signal secondary receiving device 6 such as a television broadcasting receiving device (phantom line) is connected to the second stem 41.

The light receiving element 42 converts the multimode optical signal transmitted from the optical fiber 3 into an RF signal. The light receiving element 42 is disposed on one surface of the second stem 41. The light receiving element 42 has a generally rectangular parallelepiped shape, and has one surface and the other surface in the thickness direction. The other surface faces the second stem 41, and one surface faces one side in the thickness direction. The light receiving element 42 is electrically connected to the second stem 41. The light receiving element 42 has an incidence port 44 of light disposed in one surface. The incidence port 44 faces one side in the thickness direction of the light receiving element 42 and has a generally circular shape in plan view. A diameter (inner diameter) of the incidence port 44 is appropriately set corresponding to the inner diameter C of the core 31 of the optical fiber 3, or in accordance with a required transmission band. Specifically, the diameter of the incidence port 44 is, for example, 20 µm or more, preferably 40 µm or more, and for example, 200 µm or less, preferably 100 µm or less. As the light receiving element 42, for example, a photodiode (PD) is used. As the opto-electrical conversion device 4, a commercially available product (optical receiving subassembly: ROSA (Receiver Optical SubAssembly) or the like) can be used.

In the opto-electrical conversion device 4, the multimode optical signal output from the optical fiber 3 is condensed with the second lens 43 and thereafter input to the light receiving element 42. Then, the optical signal is converted into an RF signal in the light receiving element 42. The RF signal is input from the light receiving element 42 to the RF signal secondary receiving device 6 via the second stem 41.

Then, in the electro-optical conversion device 2, the RF signal is received and converted into an optical signal to be input to the optical fiber 3. The optical signal is then input to the opto-electrical conversion device 4 by the optical fiber 3, and in the opto-electrical conversion device 4, the optical signal is converted into an RF signal. Thus, the optical transmission system 1 performs RoF transmission of the RF signal.

### Function and Effect of One Embodiment

According to the optical transmission system 1 including the optical fiber 3, since the optical fiber 3 has a numerical aperture (NA) of 0.22 or less, it is possible to suppress distortion. Further, according to the optical transmission system 1, since the optical fiber 3 has a numerical aperture (NA) of 0.13 or more, it is possible to reduce loss of light.

According to the optical transmission system 1, since the clad 32 of the optical fiber 3 has one layer, it is possible to reliably set the numerical aperture (NA) of the optical fiber 3 to 0.22 or less and 0.13 or more.

According to the optical transmission system 1, when the core 31 has an inner diameter C of 30 µm or more, it is possible to reduce coupling loss of light from the electro-optical conversion device 2 to the optical fiber 3. When the core 31 has an inner diameter C of 120 µm or less, it is possible to reduce coupling loss from the optical fiber 3 to the opto-electrical conversion device 4.

According to the optical transmission system 1, since the end surfaces 33, 34 in the optical-axis direction of the optical fiber 3 are inclined with respect to the orthogonal direction, it is possible to reduce noise caused by the return light that is reflected back by the end surfaces 33, 34 in the optical-axis direction of the optical fiber 3.

According to the optical transmission system 1, when the material of the optical fiber 3 is plastic, it is excellent in bending resistance.

### Modified Examples

In the modified examples, the same reference numerals are provided for members and steps corresponding to each of those in one embodiment, and their detailed description is omitted. Further, the modified examples can achieve the same function and effect as that of one embodiment unless otherwise specified. Furthermore, one embodiment and the modified examples thereof can be appropriately used in combination.

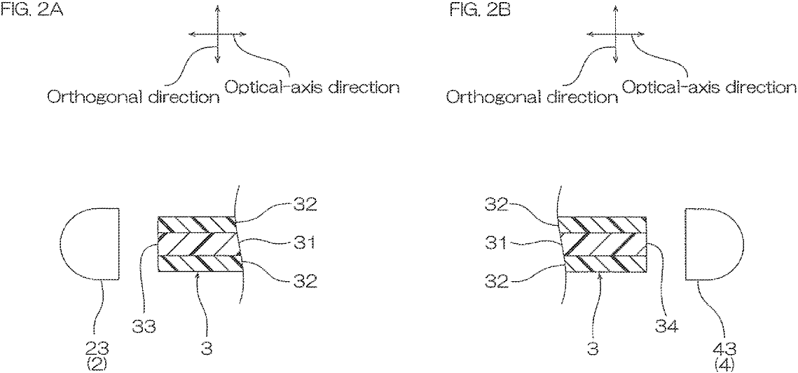

As shown in FIGS. 2A to 2B, one end surface 33 and the other end surface 34 of the optical fiber 3 may be along the orthogonal direction. That is, as shown in FIG. 2A, one end surface 33 is orthogonal to the optical-axis direction. As shown in FIG. 2B, the other end surface 34 is orthogonal to the optical-axis direction. Though not shown, one of one end surface 33 and the other end surface 34 may be inclined with respect to the orthogonal direction, and the other may be along the orthogonal direction.

Preferably, as in one embodiment, both of one end surface 33 and the other end surface 34 are inclined with respect to the orthogonal direction. Thus, it is possible to effectively reduce noise caused by the return light that is reflected back by one end surface 33 and the other end surface 34 of the optical fiber 3.

The electro-optical conversion device 2 and the opto-electrical conversion device 4 are not limited to one embodiment, and they may have a light receiving/emitting source mounted on an FPC or a PCB.

As the optical transmission system 1, a receiving system of a television broadcasting (satellite, terrestrial, cable television) may be used. In this case, the RF signal primary receiving device 5 is replaced with a transmitter, and the RF signal secondary receiving device 6 is replaced with a receiver.

In the optical transmission system 1, it is possible to replace the RF signal primary receiving device 5 with a transmission source and the RF signal secondary receiving device 6 with a transmission antenna. The RF signal is input from the transmission source to the electro-optical conversion device 2. The RF signal is input from the opto-electrical conversion device 4 to the transmission antenna.

### EXAMPLES

Next, the present invention is further described based on Examples and Comparative Examples shown below. The present invention is however not limited by these Examples and Comparative Examples. The specific numerical values in mixing ratio (ratio), property value, and parameter used in the following description can be replaced with upper limit values (numerical values defined as “or less” or “below”) or lower limit values (numerical values defined as “or more” or “above”) of corresponding numerical values in mixing ratio (ratio), property value, and parameter described in the above-described “DESCRIPTION OF THE EMBODIMENTS”.

### Example 1

As shown in FIG. 1, the optical transmission system 1 including the electro-optical conversion device 2, the optical fiber 3, and the opto-electrical conversion device 4 was prepared.

A material of the optical fiber 3, a model number, an inner diameter C of the core 31, a numerical aperture of the optical fiber 3, a configuration of the optical fiber 3, and the like were as described in Table 1.

A connection configuration including the electro-optical conversion device 2 is as follows. A TOSA-type electro-optical conversion device 2 was prepared, and a signal generator (CLG cable television multichannel signal generator) manufactured by Rohde & Schwarz Gmbh & Co. and a stabilized power source (2400 source meter) manufactured by Keithley Instruments Inc. were connected thereto via a bias tee (ZX85-12G-S+) manufactured by Mini-Circuits.

A connection configuration including the opto-electrical conversion device 4 is as follows. A ROSA-type opto-electrical conversion device 4 was prepared, and a spectrum analyzer (N9010) manufactured by Keysight Technologies and a stabilized power source (2400 source meter) manufactured by Keithley Instruments Inc. were connected thereto via a bias tee (ZX85-12G-S+) manufactured by Mini-Circuits. An amplifier (ZX60-6013E-S+) manufactured by Mini-Circuits was inserted between the opto-electrical conversion device 4 and the spectrum analyzer.

A current was shared from the stabilized power source so that the electro-optical conversion device 2 had a light output intensity of 3.5 dBm, and a 64 QAM signal in accordance with the international standards body ITU-T (International Telecommunication Union Telecommunication Standardization Sector) recommendation J.83 Annex C was input from the signal generator to the electro-optical conversion device 2 at a center frequency of 99 MHz. On the other hand, the stabilized power source applied a bias voltage of -2 V to the opto-electrical conversion device 4.

An RF signal to be RoF transmitted in a frequency band of 99 MHz was measured. In Example 1, distortion caused by a trailing phenomenon was not observed.

### Example 2

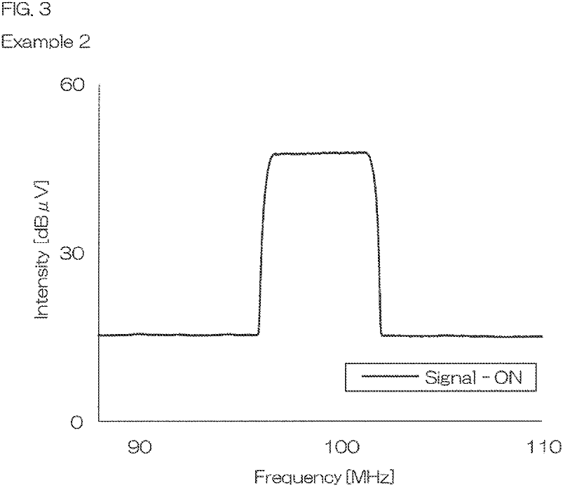

A treatment was performed in the same manner as in Example 1, except that the material of the optical fiber 3, the model number, the inner diameter C of the core 31, and the numerical aperture of the optical fiber 3 were changed as described in Table 1. In Example 2 as well, the above-described distortion was not observed. FIG. 3 shows an intensity spectrum of the RF signal to be RoF transmitted in Example 2.

### Comparative Examples 1 to 3

A treatment was performed in the same manner as in Example 1, except that the material of the optical fiber 3, the model number, the inner diameter C of the core 31, the numerical aperture of the optical fiber 3, and the configuration of the optical fiber 3 were changed as described in Table 1.

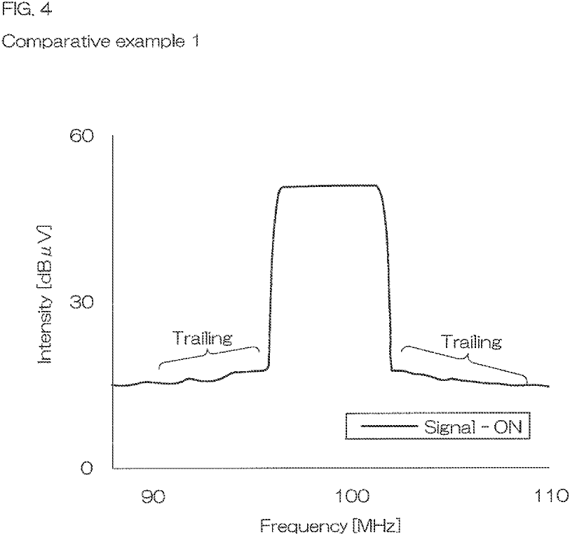

FIG. 4 shows an intensity spectrum of an RF signal to be RoF transmitted in Comparative Example 1. As shown in FIG. 4, in Comparative Example 1, distortion caused by a trailing phenomenon was observed. Also, in Comparative Examples 2 and 3, the above-described distortion was observed.

TABLE 1

| | Optical fiber | | | | | | | Evaluation |
|---|---|---|---|---|---|---|---|---|
| | Material | Model No., etc. | Inclination angle θ1 of one end surface (degree) | Inclination angle θ2 of one end surface (degree) | Inner diameter of core (µm) | Numerical aperture (NA) | Configuration | Distortion |
| Ex. 1 | Glass | Optical patch cord GI50/125 (by Miki Inc.) | 8 | 8 | 50 | 0.2 | Core/Clad | Not observed |
| Ex. 2 | Plastic | GigaPOF-50SR (by Chromis) | 14 | 14 | 50 | 0.19 | Core/Clad | Not observed |
| Comp. Ex. 1 | Plastic | FONTEX80 (by AGC) | 14 | 14 | 80 | 0.245 | Core/Clad/2nd clad | Observed |
| Comp. Ex. 2 | Plastic | FONTEX50 (by AGC) | 14 | 14 | 50 | 0.245 | Core/Clad/2nd clad | Observed |
| Comp. Ex. 3 | Glass | Optical patch cord GI62.5/125 OM1 (by Miki Inc.) | 8 | 8 | 62.5 | 0.275 | Core/Clad | Observed |

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The optical transmission system is used for RoF transmission of an RF signal.

Description of Reference Numerals

| | |
|---|---|
| 1 | optical transmission system |
| 2 | electro-optical conversion device |
| 3 | optical fiber |
| 4 | opto-electrical conversion device |
| NA | numerical aperture |
| 31 | core |
| 32 | clad |
| C | inner diameter of core |

1. An optical transmission system performing RoF transmission of an RF signal, the optical transmission system comprising:
an electro-optical conversion device for receiving an RF signal, converting the RF signal into an optical signal, and transmitting the optical signal;
a multimode optical fiber for transmitting the optical signal transmitted from the electro-optical conversion device; and
an opto-electrical conversion device for converting the optical signal transmitted from the optical fiber into an RF signal and transmitting the RF signal, wherein
the optical fiber has a numerical aperture of 0.13 or more and 0.22 or less.

2. The optical transmission system according to claim 1, wherein
the optical fiber comprises a core; and a clad covering the core, and
the clad has one layer.

3. The optical transmission system according to claim 1, wherein the core has an inner diameter of 30 µm or more and 120 µm or less.

4. The optical transmission system according to claim 1, wherein an end surface in an optical-axis direction of the optical fiber is inclined with respect to a direction orthogonal to the optical-axis direction.

5. The optical transmission system according to claim 1, wherein a material of the optical fiber is plastic.

6. An optical fiber in an optical transmission system performing RoF transmission of an RF signal,
the optical transmission system comprising: an electro-optical conversion device for receiving an RF signal, converting the RF signal into an optical signal, and transmitting the optical signal; a multimode optical fiber for transmitting the optical signal transmitted from the electro-optical conversion device; and an opto-electrical conversion device for converting the optical signal transmitted from the optical fiber into an RF signal and transmitting the RF signal,
the optical fiber having a numerical aperture of 0.13 or more and 0.22 or less.
